(19) United States
(12) Patent Application Publication
(10) Pub. No.: US 2015/0240042 A1
(43) Pub. Date: Aug. 27, 2015

(54) HIGH MODULUS FIBER REINFORCED POLYMER COMPOSITE

(71) Applicant: TORAY INDUSTRIES, INC., Chuo-ku ,Tokyo (JP)

(72) Inventors: Felix N. Nguyen, Tacoma, WA (US); Alfred P. Haro, Tacoma, WA (US); Kenichi Yoshioka, Tacoma, WA (US); Kenichi Yoshioka, Tacoma, WA (US)

(73) Assignee: Toray Industries, Inc., Chuo-ku, Tokyo (JP)

(21) Appl. No.: 14/435,577

(22) PCT Filed: Oct. 10, 2013
(86) PCT No.: PCT/IB2013/002275

§ 371 Date: Apr. 14, 2015

Related U.S. Application Data
(60) Provisional application No. 61/713,939, filed on Oct. 15, 2012.
(60) Provisional application No. 61/873,659, filed on Sep. 4, 2013.

(51) Int. Cl. C08J 5/24; C08K 7/06

(52) U.S. Cl. CPC C08J 5/24; C08K 7/06; C08J 2363/02; C08J 2363/04; C08J 2363/00

(57) ABSTRACT

A fiber reinforced polymer composition is provided comprising a fiber and an adhesive composition, wherein the adhesive composition comprises at least a thermosetting resin and a curing agent, the reinforcing fiber has a tensile modulus of at least 300 GPa and the cured adhesive has a resin modulus of at least 3.2 GPa, and the adhesive composition when cured makes good bonds to the reinforcing fiber. Additional embodiments include a prepreg comprising the fiber reinforced polymer composition and a method of manufacturing a composite article by curing the adhesive composition and a reinforcing fiber.

### INCORPORATION BY REFERENCE

The disclosures of U.S. provisional application No. 61/713,928, filed Oct. 15, 2012, U.S. provisional application No. 61/713,939, filed Oct. 15, 2012, U.S. provisional application No. 61/873,647, filed Sep. 4, 2013, and U.S. provisional application No. 61/873,659, filed Sep. 4, 2013, are each incorporated herein by reference in their entireties for all purposes.

### FIELD OF THE INVENTION

The present application provides an innovative fiber reinforced polymer composition comprising a reinforcing fiber and an adhesive composition, wherein the cured adhesive composition has a resin modulus of at least 3.2 GPa and a resin flexural deflection of at least 2 mm, and bonds well to the reinforcing fiber, which has a tensile modulus of at least 200 GPa or even higher than 300 GPa, allowing simultaneous improvements of interlaminar shear strength, fracture toughness, and compressive and tensile properties.

### BACKGROUND OF THE INVENTION

When bonding reinforcing fibers together by a resin matrix to create a fiber reinforced polymer composite, the presence of functional groups on the fiber's surface is very critical. In addition, the bond has to be durable when subjected to environmental and/or hostile conditions. Bond strength, i.e., the force per unit of interfacial area required to separate the (cured) resin from the fiber that is in contact with the cured resin, is a measure of adhesion. Maximum adhesion is obtained when a cohesive failure of either the resin or the fiber or both, as opposed to an adhesive failure between the fiber and the resin, is mainly observed.

To make a strong bond, firstly oxygen functional groups are beneficially introduced on the pristine fiber's surface; secondly an adhesion promoter may be selected such that one end of the adhesion promoter is capable of covalently bonding to the oxygen functional groups on the fiber surface while another end of the adhesion promoter is capable of promoting or participating in chemical interactions with functional groups in the resin. Essentially, the adhesion promoter acts as a bridge connecting the fiber to the bulk resin during curing. A surface treatment such as plasma, UV, corona discharge, or wet electro-chemical treatment is often used to introduce oxygen functional groups onto the fiber's surface.

Ultimately, to achieve the strong bond, there certainly cannot be voids at the interface between the fiber and the resin, i.e., there is sufficient molecular contact between them upon curing. Often, this interface is considered as a volumetric region or an interphase. The interphase can extend from the fiber's surface a few nanometers up to several micrometers, depending on the chemical composition on the sized fiber's surface, chemical interactions between the fiber and the bulk resin, and the migration of other chemical moieties to the interface during curing. The interphase, therefore, has a very unique composition, and its properties are far different from those of the fiber's surface and the bulk resin. Moreover, the existence of high stress concentrations in the interphase due to the modulus mismatch between the fiber and the resin often makes it vulnerable to crack initiation. Such high stress concentrations could be intensified by chemical embrittlement of the resin induced by the fiber, and local residual stress due to the thermal expansion coefficient difference such that when a load is applied, a catastrophic failure of the composite can be observed.

Conventionally, inadequate adhesion might allow crack energy to be dissipated along the fiber/matrix interface, but at the great expense of stress transfer capability from the adhesive through the interphase to the fibers. Strong adhesion, on the other hand, often results in an increase in interfacial matrix embrittlement, allowing cracks to initiate in these regions and propagate into the resin-rich areas. In addition, crack energy at a fiber's broken end cannot be relieved along the fiber/matrix interface, and therefore, diverted into neighboring fibers by essentially breaking them. For these reasons, current state-of-the-art fiber composite systems are designed to allow an optimal adhesion level.

Carbon fibers are the most important reinforcing fibers for structural applications, where high strength and modulus as well as light weight are required. Selection of a type of surface treatment as well as a level of surface treatment to allow bonding of a matrix resin to carbon fibers is increasingly important due to the surface structure of the pristine fiber. Precursor type, spinning process, and carbonization temperature are important parameters. A successful surface treatment should provide a uniform distribution of the oxygen functional groups on the surface without damaging the fiber and weakening it.

High modulus carbon fibers (HMCF), i.e., carbon fibers with a tensile modulus greater than 300 GPa, are important to be used in components under rotation, bending, torsion loads, or to be used under a cold temperature condition, or where high electrical and thermal properties are required. Unfortunately, due to a highly organized crystalline structure at the surface, the surface is very difficult to oxidize and therefore, bonding a resin to this type of fiber has become an ultimate challenge in the field of fiber reinforced polymer composites. As a result, use of HMCF in these applications has been very limited or could not be realized.

WO2012116261A1 (Nguyen et al., Toray Industries Inc., 2012) attempted to utilize a reinforced interphase concept by concentrating a soft interfacial material at the interfacial region between an adhesive resin composition and a HMCF. By doing so, cohesive failure of the adhesive composition was found, but the resin modulus was not high enough to transfer stress to carbon fibers. As a result, a slight increase in tensile strength and interlaminar shear strength at the expense of compression strength was observed. U.S. Pat. No. 6,515,081B2 (Oosedo et al., Toray Industries Inc., 2003) and U.S. Pat. No. 6,399,199B1 (Fujino et al., Toray Industries Inc., 2002) attempted to increase adhesion to a standard to an intermediate modulus carbon fiber (230-290 GPa) so that flexural strength could be improved by incorporating an adhesion promoter containing an amide group in a resin composition. However, a maximum interlaminar shear strength (ILSS) as a measure of adhesion strength was achieved of about 101 MPa (14.5 ksi) as a result of modest adhesion and resin modulus. In addition, adhesion level to carbon fibers with a modulus greater than 300 GPa was not shown. U.S. Pat. No. 5,599,629 (Gardner et al., Amoco Corporation, 1997) introduced a high modulus and strength epoxy resin comprising an aromatic amidoamine hardener having a single benzene ring. However, improvement of adhesion of the resin to fibers was not attempted and discussed.

### SUMMARY OF THE INVENTION

An embodiment of the invention relates to a fiber reinforced polymer composition comprising a reinforcing fiber and an adhesive composition, wherein the adhesive composition comprises at least a thermosetting resin and a curing agent, the reinforcing fiber has a tensile modulus of at least 300 GPa, the adhesive composition has a resin modulus of at least 3.2 GPa, and the adhesive composition forms good bonds to the reinforcing fiber when cured. The curing agent could comprise at least an amide group and at least one aromatic group. The curing agent could comprise at least one member selected from aminobenzamides, aminoterephthalamides, diaminobenzanilides, and aminobenzenesulfonamides. The adhesive composition may further comprise one or more of an interfacial material, a migrating agent, an accelerator, a toughener/filler, and an interlayer toughener.

Another embodiment of the invention relates to a fiber reinforced polymer composition comprising a reinforcing fiber and an adhesive composition, wherein the adhesive composition comprises at least a thermosetting resin comprising an epoxy resin and a curing agent, the curing agent comprises one or more different kinds of curing agents, wherein at least one curing agent comprises at least an amide group, an aromatic group and a curable functional group, and the adhesive composition when cured forms good bonds to the reinforcing fiber. The curing agent could comprise at least one member selected from aminobenzamides, aminoterephthalamides, diaminobenzanilides, and aminobenzenesulfonamides. The adhesive composition may further comprise one or more of an interfacial material, a migrating agent, an accelerator, a toughener/filler, and an interlayer toughener.

Another embodiment of the invention relates to a fiber reinforced polymer composition comprising a carbon fiber having a tensile modulus of at least 300 GPa and an adhesive composition, wherein the adhesive composition is comprised of at least an epoxy resin, an amidoamine curing agent, an interfacial material, and a migrating agent, wherein the epoxy resin, the amidoamine curing agent, the interfacial material and the migrating agent are selected such that the adhesive composition when cured forms good bonds to the reinforcing fiber, and wherein the interfacial material has a gradient in concentration in an interfacial region between the reinforcing fiber and the adhesive composition. The curing agent could comprise at least one member selected from aminobenzamides, diaminobenzanilides, and aminobenzenesulfonamides. The adhesive composition may further comprise one or more of an accelerator, a toughener/filler, and an interlayer toughener.

Another embodiment of the invention relates to a fiber reinforced polymer composition comprising a reinforcing fiber and an adhesive composition, wherein the adhesive composition comprises at least a thermosetting resin and an aromatic amidoamine curing agent, and wherein the fiber reinforced polymer composition when cured has an interlaminar shear strength (ILSS) of at least 90 MPa (13 ksi), a tensile strength providing a translation of at least 70%, a compression strength of at least 1380 Mpa (200 ksi), and a mode I fracture toughness of at least 350 J/m² (2 lb·in/in²).

Other embodiments relate to a prepreg comprising one of the above fiber reinforced polymer compositions.

Other embodiments relate to a method of manufacturing a composite article comprising curing one of the above fiber reinforced polymer compositions.

### DETAILED DESCRIPTION OF THE INVENTION

An embodiment of the invention relates to a fiber reinforced polymer composition comprising a reinforcing fiber and an adhesive composition, wherein the adhesive composition comprises at least a thermosetting resin and a curing agent, the reinforcing fiber has a tensile modulus of at least 300 GPa, the adhesive composition when cured has a resin modulus of at least 3.2 GPa, and the adhesive composition forms good bonds to the reinforcing fiber when cured.

In this embodiment, it is required that the adhesive composition forms good bonds to the reinforcing fiber. There are no specific limitations or restrictions on the choice of a reinforcing fiber, as long as it is has a tensile modulus of at least 300 GPa and is suitable for good bonds with the cured adhesive composition. Such reinforcing fiber, in various embodiments of the invention, has a non-polar surface energy at 30° C. of at least 30 mJ/m², at least 40 mJ/m², or even at least 50 mJ/m² and/or a polar surface energy at 30° C. of at least 2 mJ/m², at least 5 mJ/m², or even at least 10 mJ/m². High surface energies are needed to promote wetting of the adhesive composition on the reinforcing fiber. This condition is also necessary to promote good bonds.

Non-polar and polar surface energies could be measured by an inverse gas chromatography (IGC) method using vapors of probe liquids and their saturated vapor pressures. IGC can be performed according to Sun and Berg's publications (Advances in Colloid and Interface Science 105 (2003) 151-175 and Journal of Chromatography A, 969 (2002) 59-72). A brief summary is described in the paragraph below.

Vapors of known liquid probes are carried into a tube packed with solid materials of unknown surface energy and interacted with the surface. Based on the time that a gas traverses through the tube and the retention volume of the gas, the free energy of adsorption can be determined. Hence, the non-polar surface energy can be determined from a series of alkane probes, whereas the polar surface energy can be roughly estimated using two acid/base probes.

The form and the arrangement of a plurality of the reinforcing fibers used are not specifically defined. Any of the forms and spatial arrangements of the reinforcing fibers known in the art such as long fibers in a direction, chopped fibers in random orientation, single tow, narrow tow, woven fabrics, mats, knitted fabrics, and braids can be employed. The term “long fiber” as used herein refers to a single fiber that is substantially continuous over 10 mm or longer or a fiber bundle comprising the single fibers. The term “short fibers” as used herein refers to a fiber bundle comprising fibers that are cut into lengths of shorter than 10 mm. Particularly in the use applications for which high specific strength and high specific elastic modulus are required, a form wherein a reinforcing fiber bundle is arranged in one direction may be most suitable. From the viewpoint of ease of handling, a cloth-like (woven fabric) form is also suitable for the present invention.

Among the reinforcing fibers, carbon fiber in particular is used to provide the cured fiber reinforced polymer composition exceptionally high strength and stiffness as well as light weight. Examples of such high modulus carbon fibers are M35J, M40J, M46J, M50J, M55J, and M60J from Toray Industries Inc.

In cases when the reinforcing fiber is a carbon fiber, instead of using surface energies described above for a selection of suitable carbon fibers, an interfacial shear strength (IFSS) value of at least 5 MPa, at least 10 MPa, or even at least 15 MPa, determined in a single fiber fragmentation test (SFFT) according to Rich et al. in “Round Robin Assessment of the Single Fiber Fragmentation Test” in Proceeding of the American Society for Composites: 17th Technical conference (2002), paper 158 could be needed. A brief description of SFFT is described in a paragraph below.

A single fiber composite coupon having a single carbon fiber embedded in the center of a dog-boned cured resin is strained without breaking the coupon until the set fiber length no longer produces fragments. IFSS is determined from the fiber strength, the fiber diameter, and the critical fragment length determined by the set fiber length divided by the number of fragments.

In order to achieve such high IFSS, the carbon fiber typically is oxidized or surface treated by an available method in the art (e.g., plasma treatment, UV treatment, plasma assisted microwave treatment, and/or wet chemical-electrical oxidization) to increase its concentration of oxygen to carbon (O/C). The O/C concentration can be measured by an X-ray photoelectron spectroscopy (XPS). A desired O/C concentration may be at least 0.05, at least 0.1, or even at least 0.15. The oxidized carbon fiber is coated with a sizing material such as an organic material or organic/inorganic material such as a silane coupling agent or a silane network or a polymer composition compatible and/or chemically reactive with the adhesive composition to improve bonding strengths. For example, if the adhesive resin composition comprises an epoxy, the sizing material could have functional groups such as epoxy groups, amine groups, amide groups, carboxylic groups, carbonyl groups, hydroxyl groups, and other suitable oxygen-containing or nitrogen-containing groups. Both the O/C concentration on the surface of the carbon fiber and the sizing material collectively are selected to promote adhesion of the adhesive composition to the carbon fiber. There is no restriction on the possible choices of the sizing material as long as the requirement of surface energies of the carbon fiber is met and/or the sizing promotes good bonds.

Good adhesion between the adhesive composition and the reinforcing fiber herein refers to “good bonds” in that one or more components of the adhesive composition chemically react with functional groups found on the reinforcing fiber's surface to form cross-links. Good bonds can be documented by examining the cured fiber reinforced polymer composition after being fractured under a scanning electron microscope (SEM) for failure modes. Adhesive failure refers to a fracture failure at the interface between the reinforcing fiber and the cured adhesive composition, exposing the fiber's surface with little or no adhesive found on the surface. Cohesive failure refers to a fracture failure which occurs in the adhesive composition, wherein the fiber's surface is mainly covered with the adhesive composition. Note that cohesive failure in the fiber may occur, but it is not referred to in the invention herein. The coverage of the fiber surface with the cured adhesive composition could be about 50% or more, or about 70% or more. Mixed mode failure refers to a combination of adhesive failure and cohesive failure, collectively having a fiber coverage of at least 20% or even at least 30%. Adhesive failure refers to weak adhesion and cohesive failure is strong adhesion, while mixed mode failure results in adhesion somewhere in between weak adhesion and strong adhesion. Mixed mode and cohesive failures herein are referred to as a good bond between the cured adhesive composition and the fiber surface while adhesive failure constitutes a poor bond. To have good bonds between carbon fibers and the cured adhesive composition an IFSS value of at least 5 MPa, at least 10 MPa or even at least 20 MPa could be needed. Alternatively, a measurement of fiber-matrix adhesion could be obtained by interlaminar shear strength (ILSS) described by ASTM D-2344 of the cured fiber reinforced polymer composition. Good bonds could refer to an IFSS of at least 10 MPa, at least 15 MPa or even at least 20 MPa and/or a value of ILSS of at least 13 ksi, at least 14 ksi, at least 15 ksi, at least 16 ksi, or even at least 17 ksi. Ideally, both an observation of failure modes and an IFSS value are needed to confirm good bonds. However, generally, when either observations of failure modes or an IFSS value cannot be obtained, an ILSS value between 14-15 ksi could indicate a mixed mode failure while an ILSS value above 16 ksi could indicate a cohesive failure and an ILSS value between 15-16 ksi could indicate either mixed mode or cohesive failure, depending on the reinforcing fiber and the adhesive composition.

The adhesive composition when cured has a flexural resin modulus (hereafter called “resin modulus” at room temperature dry measured in accordance with a three point bend method described in ASTM D-790) of at least 3.2 GPa. There is no restriction or limitation of or the number of components in the adhesive composition as long as it has a resin modulus of at least 3.2 GPa. When a resin modulus is at least 3.2 GPa and the adhesive composition make good bonds to the reinforcing fiber, it provides the cured fiber reinforced polymer composition excellent compression strength, open-hole compression strength and 0° flexural strength in that a higher resin modulus than 3.2 GPa tends to provide the higher strengths and yet, in some cases tension strength and/or 90° flexural strength might be sacrificed to some extent. Nevertheless, when the cured adhesive composition might need to have a flexural deflection of at least 3 mm, the cured fiber reinforced polymer composition can maintain or improve those strengths.

The thermosetting resin in the adhesive composition may be defined herein as any resin which can be cured with a curing agent or a cross-linker compound by means of an externally supplied source of energy (e.g., heat, light, electromagnetic waves such as microwaves, UV, electron beam, or other suitable methods) to form a three dimensional crosslinked network having the required resin modulus. The thermosetting resin may be selected from, but is not limited to, epoxy resins, epoxy novolac resins, ester resins, vinyl ester resins, cyanate ester resins, maleimide resins, bismaleimide-triazine resins, phenolic resins, novolac resins, resorcinolic resins, unsaturated polyester resins, diallylphthalate resins, urea resins, melamine resins, benzoxazine resins, polyurethanes, and mixtures thereof and mixtures thereof, as long as it provides the resin modulus and the good bonds needed to satisfy the above conditions.

From the view point of an exceptional balance of strength, strain, modulus and environmental effect resistance, of the above thermosetting resins, epoxy resins could be used, including mono-, di-functional, and higher functional (or multifunctional) epoxy resins and mixtures thereof. Multifunctional epoxy resins are preferably selected as they provide excellent glass transition temperature (Tg), modulus and even high adhesion to a reinforcing fiber. These epoxies are prepared from precursors such as amines (e.g., epoxy resins prepared using diamines and compounds containing at least one amine group and at least one hydroxyl group such as tetraglycidyl diaminodiphenyl methane, triglycidyl-p-aminophenol, triglycidyl-m-aminophenol, triglycidyl aminocresol and tetraglycidyl xylylenediamine and their isomers), phenols (e.g., bisphenol A epoxy resins, bisphenol F epoxy resins, bisphenol S epoxy resins, bisphenol R epoxy resins, phenol-novolac epoxy resins, cresol-novolac epoxy resins and resorcinol epoxy resins), naphthalene epoxy resins, dicyclopentadiene epoxy resins, epoxy resins having a biphenyl skeleton, isocyanate-modified epoxy resins and compounds having a carbon-carbon double bond (e.g., alicyclic epoxy resins). It should be noted that the epoxy resins are not restricted to the examples above. Halogenated epoxy resins prepared by halogenating these epoxy resins can also be used. Furthermore, mixtures of two or more of these epoxy resins, and compounds having one epoxy group or monoepoxy compounds such as glycidylaniline, glycidyl toluidine or other glycidylamines (particularly glycidylaromatic amines) can be employed in the formulation of the thermosetting resin matrix.

Examples of commercially available products of bisphenol A epoxy resins include “jER (registered trademark)” 825, “jER (registered trademark)” 828, “jER (registered trademark)” 834, “jER (registered trademark)” 1001, “jER (registered trademark)” 1002, “jER (registered trademark)” 1003, “jER (registered trademark)” 1003F, “jER (registered trademark)” 1004, “jER (registered trademark)” 1004AF, “jER (registered trademark)” 1005F, “jER (registered trademark)” 1006FS, “jER (registered trademark)” 1007, “jER (registered trademark)” 1009 and “jER (registered trademark)” 1010 (which are manufactured by Mitsubishi Chemical Corporation). Examples of commercially available products of brominated bisphenol A epoxy resins include “jER (registered trademark)” 505, “jER (registered trademark)” 5050, “jER (registered trademark)” 5051, “jER (registered trademark)” 5054 and “jER (registered trademark)” 5057 (which are manufactured by Mitsubishi Chemical Corporation). Examples of commercially available products of hydrogenated bisphenol A epoxy resins include ST5080, ST4000D, ST4100D and ST5100 (which are manufactured by Nippon Steel Chemical Co., Ltd.).

Examples of commercially available products of bisphenol F epoxy resins include “jER (registered trademark)” 806, “jER (registered trademark)” 807, “jER (registered trademark)” 4002P, “jER (registered trademark)” 4004P, “jER (registered trademark)” 4007P, “jER (registered trademark)” 4009P and “jER (registered trademark)” 4010P (which are manufactured by Mitsubishi Chemical Corporation), and “Epotohto (registered trademark)” YDF2001 and “Epotohto (registered trademark)” YDF2004 (which are manufactured by Nippon Steel Chemical Co., Ltd.). An example of a commercially available product of a tetramethyl-bisphenol F epoxy resin is YSLV-80XY (manufactured by Nippon Steel Chemical Co., Ltd.).

An example of a bisphenol S epoxy resin is “Epiclon (registered trademark)” EXA-154 (manufactured by DIC Corporation).

Examples of commercially available products of tetraglycidyl diaminodiphenyl methane resins include “Sumiepoxy (registered trademark)” ELM434 (manufactured by Sumitomo Chemical Co., Ltd.), YH434L (manufactured by Nippon Steel Chemical Co., Ltd.), “jER (registered trademark)” 604 (manufactured by Mitsubishi Chemical Corporation), and “Araldite (registered trademark)” MY720 and MY721 (which are manufactured by Huntsman Advanced Materials). Examples of commercially available products of triglycidyl aminophenol or triglycidyl aminocresol resins include “Sumiepoxy (registered trademark)” ELM100 (manufactured by Sumitomo Chemical Co., Ltd.), “Araldite (registered trademark)” MY0500, MY0510 and MY0600 (which are manufactured by Huntsman Advanced Materials) and “jER (registered trademark)” 630 (manufactured by Mitsubishi Chemical Corporation). Examples of commercially available products of tetraglycidyl xylylenediamine resins and hydrogenated products thereof include TETRAD-X and TETRAD-C(which are manufactured by Mitsubishi Gas Chemical Company, Inc.).

Examples of commercially available products of phenol-novolac epoxy resins include “jER (registered trademark)” 152 and “jER (registered trademark)” 154 (which are manufactured by Mitsubishi Chemical Corporation), and “Epiclon (registered trademark)” N-740, N-770 and N-775 (which are manufactured by DIC Corporation).

Examples of commercially available products of cresol-novolac epoxy resins include “Epiclon (registered trademark)” N-660, N-665, N-670, N-673 and N-695 (which are manufactured by DIC Corporation), and EOCN-1020, EOCN-102S and EOCN-104S (which are manufactured by Nippon Kayaku Co., Ltd.).

An example of a commercially available product of a resorcinol epoxy resin is “Denacol (registered trademark)” EX-201 (manufactured by Nagase chemteX Corporation).

Examples of commercially available products of a naphthalene epoxy resins include HP-4032, HP4032D, HP-4700, HP-4710, HP-4770, EXA-4701, EXA-4750, EXA-7240 (which are manufactured by DIC Corporation)

Examples of commercially available products of dicyclopentadiene epoxy resins include “Epiclon (registered trademark)” HP7200, HP7200L, HP7200H and HP7200HH (which are manufactured by DIC Corporation), “Tactix (registered trademark)” 558 (manufactured by Huntsman Advanced Material), and XD-1000-1L and XD-1000-2L (which are manufactured by Nippon Kayaku Co., Ltd.).

Examples of commercially available products of epoxy resins having a biphenyl skeleton include “jER (registered trademark)” YX4000H, YX4000 and YL6616 (which are manufactured by Mitsubishi Chemical Corporation), and NC-3000 (manufactured by Nippon Kayaku Co., Ltd.).

Examples of commercially available products of isocyanate-modified epoxy resins include AER4152 (manufactured by Asahi Kasei Epoxy Co., Ltd.) and ACR1348 (manufactured by ADEKA Corporation), each of which has an oxazolidone ring.

The thermosetting resin may comprise both a tetrafunctional epoxy resin (in particular, a tetraglycidyldiaminodiphenyl methane epoxy resin) and a difunctional glycidylamine, in particular a difunctional glycidyl aromatic amine such as glycidyl aniline or glycidyl toluidine from the view point of the required resin modulus. A difunctional epoxy resin, such as a difunctional bisphenol A or F/epichlorohydrin epoxy resin could be used to provide an increase in a flexural deflection of the cured adhesive composition; the average epoxy equivalent weight (EEW) of the difunctional epoxy resin may be, for example from 177 to 1500, for example. For example, the thermosetting resin may comprise 50 to 70 weight % tetrafunctional epoxy resin, 10 to 30 weight percent difunctional bisphenol A or F/epichlorohydrin epoxy resin, and 10 to 30 weight percent difunctional glycidyl aromatic amine.

The adhesive composition also includes a curing agent or a cross-linker compound for the thermosetting resin. There are no specific limitations or restrictions on the choice of a compound as the curing agent, as long as it has at least one active group which reacts with the thermosetting resin and collectively provides the required resin modulus and/or promotes adhesion.

For the above epoxy resins, examples of suitable curing agents include polyamides, dicyandiamide [DICY], amidoamines (e.g., aromatic amidoamines such as aminobenzamides, aminobenzanilides, and aminobenzenesulfonamides), aromatic diamines (e.g., diaminodiphenylmethane, diaminodiphenylsulfone [DDS]), aminobenzoates (e.g., trimethylene glycol di-p-aminobenzoate and neopentyl glycol di-p-amino-benzoate), aliphatic amines (e.g., triethylenetetramine, isophoronediamine), cycloaliphatic amines (e.g., isophorone diamine), imidazole derivatives, guanidines such as tetramethylguanidine, carboxylic acid anhydrides (e.g., methylhexahydrophthalic anhydride), carboxylic acid hydrazides (e.g., adipic acid hydrazide), phenol-novolac resins and cresol-novolac resins, carboxylic acid amides, polyphenol compounds, polysulfides and mercaptans, and Lewis acids and bases (e.g., boron trifluoride ethylamine, tris-(diethylaminomethyl) phenol). Depending on the desired properties of the cured fiber reinforced epoxy composition, a suitable curing agent or suitable combination of curing agents is selected from the above list. For example, if dicyandiamide is used, it will generally provide the product with good elevated-temperature properties, good chemical resistance, and a good combination of tensile and peel strength. Aromatic diamines, on the other hand, will typically give moderate heat and chemical resistance and high modulus. Aminobenzoates will generally provide excellent tensile elongation though they often provide inferior heat resistance compared to aromatic diamines. Acid anhydrides generally provide the resin matrix with low viscosity and excellent workability, and subsequently, high heat resistance after curing. Phenol-novolac resins and cresol-novolac resins provide moisture resistance due to the formation of ether bonds, which have excellent resistance to hydrolysis. Note that a mixture of two or more above curing agents could be employed. For example, by using DDS together with DICY as the hardener, the reinforcing fiber and the adhesive composition could adhere more firmly, and in particular, the heat resistance, the mechanical properties such as compressive strength, and the environmental resistance of the fiber reinforced composite material obtained may be markedly enhanced. In another example when DDS is combined with an aromatic amidoamine (e.g., 3-aminobenzamide), an excellent balance of thermal, mechanical properties and environmental resistance could be achieved.

The curing agent in the invention may comprise at least an amide group and an aromatic group, wherein the amide group is selected from an organic amide group, a sulfonamide group or a phosphoramide group, or collectively their combinations. The amide group provides not only improved adhesion of the adhesive composition to the reinforcing fiber, but also promotes high resin modulus without penalizing strain due to hydrogen bond formations. The curing agent additionally comprises one or more of curable functional groups such as nitrogen-containing groups (e.g., an amine group), a hydroxyl group, a carboxylic acid group, and an anhydride group. Amine groups in particular tend to provide higher crosslink density and hence improved resin modulus. A curing agent having at least an amide group and amine group is herein referred to as an ‘amidoamine’ curing agent. Curing agents having a chemical structure which comprises at least an aromatic group, an amide group and an amine group are referred to herein as “aromatic amidoamines.” Generally speaking, increasing the number of benzene rings that an aromatic amidoamine has tends to result in a higher resin modulus.

The additional curable functional group and/or the amide group may be substituted on an aromatic ring. The nitrogen atom of the amide group may be unsubstituted (so as to provide, for example, an amide group having the structure —C(═O)NH₂, —SO₂NH₂ or —PO₂NH₂) or may be substituted with one or two substituents such as alkyl, aryl and/or aralkyl groups, for example. Aromatic amidoamines, for example, are suitable for use as the curing agent in the present invention. Examples of the above-mentioned curing agents include, but are not limited to, benzamides, benzanilides, and benzenesulfonamides (including not only the base compounds but substituted derivatives, such as compounds wherein the nitrogen atom of the amide group and/or the benzene ring is substituted with one or more substituents such as alkyl groups, aryl groups, aralkyl groups, non-hydrocarbyl groups and the like), aminobenzamides and derivatives or isomers thereof, including compounds such as anthranilamide (o-aminobenzamide, 2-aminobenzamide), 3-aminobenzamide, 4-aminobenzamide, aminoterephthalamides and derivatives or isomers thereof such as 2-aminoterephthalamide, N,N′-Bis(4-aminophenyl) terephthalamide, diaminobenzanilides and derivatives or isomers thereof such as 2,3-diaminobenzanilide, 3,3-diaminobenzanilide, 3,4-diaminobenzanilide, 4,4-diaminobenzanilide, aminobenzenesulfonamides and derivatives or isomers thereof such as 2-aminobenzenesulfonamide, 3-aminobenzenesulfonamide, 4-aminobenzenesulfonamide (sulfanilamide), 4-(2-aminoethyl)benzenesulfonamide, and N-(phenylsulfonyl)benzenesulfonamide, and sulfonylhydrazides such as p-toluenesulfonylhydrazide. Among the aromatic amidoamine curing agents, aminobenzamides, diaminobenzanilides, and aminobenzenesulfonamides are suitable to provide excellent resin modulus and ease of processing.

The curing agent(s) are employed in an amount up to about 75 parts by weight per 100 parts by weight of total thermosetting resin (75 phr). The curing agent might also be used in an amount higher or lower than a stoichiometric ratio between the thermosetting resin equivalent weight and the curing agent equivalent weight to increase resin modulus or glass transition temperature or both. In such cases, an equivalent weight of the curing agent is varied by the number of reaction sites or active hydrogen atoms and is calculated by dividing its molecular weight by the number of active hydrogen atoms. For example, an amine equivalent weight of 2-aminobenzamide (molecular weight of 136) could be 68 for 2 functionality, 45.3 for 3 functionality, 34 for 4 functionality, 27.2 for 5 functionality.

The adhesive composition could include either a thermosetting resin comprising at least an amide group or a curing agent comprising at least an amide group or both a thermosetting resin and a curing agent which each comprise at least an amide group to provide both high resin modulus and exceptional adhesion to the reinforcing fibers. The amide group when incorporated in a cured network could increase resin modulus without penalizing significant strain due to hydrogen bond formations. Such a thermosetting agent, curing agent or additive(s) comprising the amide group or other groups having the aforementioned characteristics is referred to herein as an epoxy fortifying agent or an epoxy fortifier. In such a case a resin modulus of at least 4.0 GPa and a flexural deflection of at least 4 mm could be observed. Such systems are important to improve both compressive as well as fracture toughness properties of the fiber reinforced polymer composition. Increasing the number of benzene rings that a compound has generally leads to a higher resin modulus. In addition, an isomer of either the thermosetting or the curing agent can be used. Isomers herein refer to compounds comprising identical numbers of atoms and groups, wherein the locations of one or more groups are different. For example, the amide group and the amine group of an aminobenzamide could be located relative to each other on a benzene ring at ortho (1, 2), meta (1, 3), or para (1, 4) positions to form 2-aminobenzamide, 3-aminobenzamide, and 4-aminobenzamide, respectively. Placing the groups at positions which are ortho or meta to each other tends to result in a higher resin modulus as compared to the resin modulus obtained when the groups are positioned para to each other.

Another method to achieve the required resin modulus could be to use a combination of the above epoxy resins and benzoxazine resins. Examples of suitable benzoxazine resins include, but are not limited to, multi-functional n-phenyl benzoxazine resins such as phenolphthaleine based, thiodiphenyl based, bisphenol A based, bisphenol F based, and/or dicyclopentadiene based benzoxazines. When an epoxy resin or a mixture of epoxy resins with different functionalities is used with a benzoxazine resin or a mixture of benzoxazine resins of different kinds, the weight ratio of the epoxy resin(s) to the benzoxazine resin(s) could be between 0.01 and 100. Yet another method is to incorporate high modulus additives into the adhesive composition. Examples of high modulus additives include, but are not limited to, oxides (e.g., silica), clays, polyhedral oligomeric silsesquioxanes (POSS), carbonaceous materials (e.g., carbon nanotubes with and without substantial alignment, carbon nanoplatelets, carbon nanofibers, fibrous materials (e.g., nickel nanostrand, halloysite), ceramics, silicon carbides, diamonds, and mixtures thereof.

The adhesive composition could further comprise an interfacial material and a migrating agent to promote even better bonds. There are no specific limitations or restrictions on the choice of a compound as the interfacial material, as long as it can migrate to the vicinity of the reinforcing fiber and preferably stays there due to its surface chemistry being more compatible with the substances on the reinforcing fiber than with the substances present in the bulk adhesive composition and subsequently becomes a part of an interfacial region between the cured adhesive composition and the reinforcing fiber (herein referred to as an interphase. The interfacial material may comprise at least one material selected from the group consisting of polymers, core-shell particles, inorganic materials, metals, oxides, carbonaceous materials, organic-inorganic hybrid materials, polymer grafted inorganic materials, organofunctionalized inorganic materials, polymer grafted carbonaceous materials, organofunctionalized carbonaceous materials and combinations thereof. The interfacial material is insoluble or partially soluble in the adhesive composition after the adhesive composition is cured.

Depending on the desired function of the interphase, a suitable interfacial material is selected. For example, soft interfacial materials such as core-shell particles could provide both dramatic improvement in tensile strength and mode I fracture toughness while harder interfacial material such as oxide particles increase both compressive properties and tensile strength. The interfacial material can be used in an amount up to 50 weight parts per 100 weight parts of the thermosetting resin (50 phr). Lower amounts could be used to control interfacial properties such as fracture toughness and stiffness affecting tensile-related, adhesion-related and compressive properties without influencing the bulk adhesive composition's properties that might drive these properties in a negative direction. An example is core-shell rubber, which may be used in an amount of about 5 phr for the interphase to avoid having an excessive amount of this material in the bulk resin, which causes a reduction in resin modulus and in turn affecting compressive properties. To the contrary, high amounts of interfacial material could be used to increase both the interfacial properties and the bulk adhesive composition's properties. For example, silica can be used at an amount of 25 phr to substantially increase both interfacial modulus and the resin modulus, leading to a substantial envelope performance in the direction of compressive properties.

The migrating agent herein is any material inducing one or more components in the adhesive composition to be more concentrated in an interfacial region between the fiber and the adhesive composition upon curing of the adhesive composition. This phenomenon is a migration process of the interfacial material to the vicinity of the fiber, which hereafter is referred to as particle migration or interfacial material migration. In such a case, it is said that the interfacial material is more compatible with the reinforcing fiber than the migration agent. Compatibility refers to chemically like molecules, or chemically alike molecules, or molecules whose chemical makeup comprises similar atoms or structure, or molecules that associate with one another and possibly chemically interact with one another. Compatibility implies solubility of one component in another component and/or reactivity of one component with another component. “Not compatible/incompatible” or “does not like” refers to a phenomenon wherein the migrating agent, when present at a certain amount (concentration) in the adhesive composition, causes the interfacial material, which in the absence of the migrating agent would have been uniformly distributed in the adhesive composition after curing, to be not uniformly distributed to some extent.

Any material found more concentrated in a vicinity of the fiber than further away from the fiber or present in the interfacial region or the interphase between the fiber's surface to a definite distance into the cured adhesive composition constitutes an interfacial material in the present adhesive composition. Note that one interfacial material can play the role of a migrating agent for another interfacial agent if it can cause the second interfacial material to have a higher concentration in a vicinity of the fiber than further away from the fiber upon curing of the adhesive composition.

The migrating agent may comprise a polymer, a thermoplastic resin, a thermosetting resin, or a combination thereof. In one embodiment of the invention, the migrating agent is a thermoplastic polymer or combination of thermoplastic polymers. Typically, the thermoplastic polymer additives are selected to modify the viscosity of the thermosetting resin for processing purposes, and/or enhance its toughness, and yet could affect the distribution of the interfacial material in the adhesive composition to some extent. The thermoplastic polymer additives, when present, may be employed in any amount up to 50 parts by weight per 100 parts of the thermosetting resin (50 phr), or up to 35 phr for ease of processing. Typically, the adhesive composition contains from about 5 to about 35 parts by weight migrating agent per 100 parts by weight of the thermosetting resin. A suitable amount of the migrating agent is determined based on its migrating-driving ability versus mobility of the interfacial material restricted by viscosity of the adhesive composition. Note that when the viscosity of the adhesive composition is adequately low, a uniform distribution of the interfacial material in the adhesive composition might not be necessary to promote particle migration onto or near the fiber's surface. As the viscosity of the adhesive composition increases to some extent, a uniform distribution of the interfacial material in the adhesive composition could help improve particle migration onto or near the fiber's surface.

For the migrating agent, one could use, but is not limited to, the following thermoplastic materials such as polyvinyl formals, polyamides, polycarbonates, polyacetals, polyphenyleneoxides, poly phenylene sulfides, polyarylates, polyesters, polyamideimides, polyimides, polyetherimides, polyimides having phenyltrimethylindane structure, polysulfones, polyethersulfones, polyetherketones, polyetheretherketones, polyaramids, polyethernitriles, polybenzimidazoles, their derivatives and their mixtures thereof.

One could use as the migrating agent aromatic thermoplastic polymer additives which do not impair the high thermal resistance and high elastic modulus of the resin. The selected thermoplastic polymer additive could be soluble in the resin to a large extent to form a homogeneous mixture. The thermoplastic polymer additives could be compounds having aromatic skeletons which are selected from the group consisting of polysulfones, polyethersulfones, polyamides, polyamideimides, polyimides, polyetherimides, polyetherketones, polyetheretherketones, and polyvinyl formals, their derivatives, the alike or similar polymers, and mixtures thereof. Polyethersulfones and polyetherimides and mixtures thereof could be of interest due to their exceptional migrating-drive abilities. Suitable polyethersulfones, for example, may have a number average molecular weight of from about 10,000 to about 75,000.

When both migrating agent and interfacial material are present in the adhesive compositions, the migrating agent and the interfacial material may be present in a weight ratio of migrating agent to interfacial material of from about 0.1 to about 30, or from about 0.1 to about 20. This range is necessary for particle migration and subsequently the interphase formation.

The interphase comprises at least the interfacial material to form a reinforced interphase necessary to reduce stress concentration in this region and allow a substantially improved envelope performance of the cured reinforced polymer composition, which could not achieved without such a reinforced interphase. In order to create the reinforced interphase it is required to have a reinforcing fiber providing a compatible surface chemistry with the surface chemistry of the interfacial material and the migration process is further driven by the migrating agent. Such reinforcing fiber, in various embodiments of the invention, has a non-polar surface energy at 30° C. of at least 30 mJ/m², at least 40 mJ/m², or even at least 50 mJ/m² and/or a polar surface energy at 30° C. of at least 2 mJ/m², at least 5 mJ/m², or even at least 10 mJ/m². The interfacial material is concentrated in-situ in the interfacial region during curing of the adhesive composition such that the interfacial material has a gradient in concentration in the interfacial region, more concentrated closer to the reinforcing fiber than further away where the migrating agent is present at a higher amount. The composition of the reinforced interphase could be very unique for each fiber reinforced polymer composition to achieve the observed properties, even though this may not be capable of being quantitatively documented due to the limitations of current state-of-the-art analytical instruments, and yet presumably comprises functional groups on the fiber surface or surface chemistry, sizing material, interfacial material, and other component(s) in the bulk resin that could migrate into the vicinity of the reinforcing fibers. For carbon fibers in particular, surface functional groups depend on the modulus of carbon fibers, their surface characteristics, and the type of surface treatment used. Synergistic effects of a combination of (1) the reinforced interphase, (2) good bonds and (3) the resin modulus of at least 4.0 GPa provide an excellent performance envelope comprising at least tensile strength, compressive strength, fracture toughness and interlaminar shear strength of the cured fiber reinforced polymer composition. This might not be achieved by individual elements or the combination of two elements alone.

The adhesive composition may optionally include an accelerator. There are no specific limitations or restrictions on the choice of a compound as the accelerator, as long as it can accelerate reactions between the resin and the curing agent and does not deteriorate the effects of the invention. Examples include urea compounds, sulfonate compounds, boron trifluoride piperidine, p-t-butylcatechol, sulfonate compounds (e.g., ethyl p-toluenesulfonate or methyl p-toluenesulfonate), a tertiary amine or a salt thereof, an imidazole or a salt thereof, phosphorus curing accelerators, metal carboxylates and a Lewis or Bronsted acid or a salt thereof.

Examples of such a urea compound include N,N-dimethyl-N′-(3,4-dichlorophenyl) urea, toluene bis(dimethylurea), 4,4′-methylene his (phenyl dimethylurea), and 3-phenyl-1,1-dimethylurea. Commercial products of such a urea compound include DCMU99 (manufactured by Hodogaya Chemical Co., Ltd.), and Omicure (registered trademark) 24, 52 and 94 (all manufactured by CVC Specialty Chemicals, Inc.).

Commercial products of an imidazole compound or derivative thereof include 2MZ, 2PZ and 2E4MZ (all manufactured by Shikoku Chemicals Corporation). Examples of a Lewis acid catalyst include complexes of a boron trihalide and a base, such as a boron trifluoride piperidine complex, boron trifluoride monoethyl amine complex, boron trifluoride triethanol amine complex, boron trichloride octyl amine complex, methyl p-toluenesulfonate, ethyl p-toluenesulfonate and isopropyl p-toluenesulfonate.

The adhesive composition optionally may contain additional additives such as a toughening agent/filler, an interlayer toughener, or a combination thereof to further improve mechanical properties such as toughness or strength or physical/thermal properties of the cured fiber reinforced polymer composition as long as the effects of the present invention are not deteriorated.

One or more polymeric and/or inorganic toughening agents/fillers can be used. Toughening agents are also referred to as tougheners. The toughening agent may be uniformly distributed in the form of particles in the cured fiber reinforced polymer composition. The particles could be less than 5 microns in diameter, or even less than 1 micron in diameter. The shortest dimension of the particles could be less than 300 nm. When a toughening agent is needed to toughen the thermosetting resin in the fiber bed, the longest dimension of the particles could be no more than 1 micron. Such toughening agents include, but are not limited to, elastomers, branched polymers, hyperbranched polymers, dendrimers, rubbery polymers, rubbery copolymers, block copolymers, core-shell particles, oxides or inorganic materials such as clay, polyhedral oligomeric silsesquioxanes (POSS), carbonaceous materials (e.g., carbon black, carbon nanotubes, carbon nanofibers, fullerenes), ceramics and silicon carbides, with or without surface modification or functionalization. Examples of block copolymers include the copolymers whose composition is described in U.S. Pat. No. 6,894,113 (Court et al., Atofina, 2005) and include “Nanostrength®” SBM (polystyrene-polybutadiene-polymethacrylate), and AMA (polymethacrylate-polybutylacrylate-polymethacrylate), both produced by Arkema. Other suitable block copolymers include Fortegra® and the amphiphilic block copolymers described in U.S. Pat. No. 7,820,760B2, assigned to Dow Chemical. Examples of known core-shell particles include the core-shell (dendrimer) particles whose compositions are described in US20100280151A1 (Nguyen et al., Toray Industries, Inc., 2010) for an amine branched polymer as a shell grafted to a core polymer polymerized from polymerizable monomers containing unsaturated carbon-carbon bonds, core-shell rubber particles whose compositions are described in EP 1632533A1 and EP 2123711A1 by Kaneka Corporation, and the “KaneAce MX” product line of such particle/epoxy blends whose particles have a polymeric core polymerized from polymerizable monomers such as butadiene, styrene, other unsaturated carbon-carbon bond monomer, or their combinations, and a polymeric shell compatible with the epoxy, typically polymethylmethacrylate, polyglycidylmethacrylate, polyacrylonitrile or similar polymers. Also suitable as block copolymers in the present invention are the “JSR SX” series of carboxylated polystyrene/polydivinylbenzenes produced by JSR Corporation; “Kureha Paraloid” EXL-2655 (produced by Kureha Chemical Industry Co., Ltd.), which is a butadiene alkyl methacrylate styrene copolymer; “Stafiloid” AC-3355 and TR-2122 (both produced by Takeda Chemical Industries, Ltd.), each of which are acrylate methacrylate copolymers; and “PARALOID” EXL-2611 and EXL-3387 (both produced by Rohm & Haas), each of which are butyl acrylate methyl methacrylate copolymers. Examples of suitable oxide particles include Nanopox® produced by nanoresins AG. This is a master blend of functionalized nanosilica particles and an epoxy.

The interlayer toughener could be thermoplastics, elastomers, or combinations of an elastomer and a thermoplastic, or combinations of an elastomer and an inorganic such as glass, or pluralities of nanofibers or micronfibers. If the interlayer toughener is a particulate, the average particle size of interlayer tougheners could be no more than 100 μm, or 10-50 μm, to keep them in the interlayer after curing to provide maximum toughness enhancement. The particles are said to be localized outside of a plurality of the reinforcing fibers. Such particles are generally employed in amounts of up to about 30%, or up to about 15% by weight (based upon the weight of total resin content in the composite composition). Examples of suitable thermoplastic materials include polyamides. Known polyamide particles include SP-500, produced by Toray Industries, Inc., “Orgasol®” produced by Arkema, and Grilamid® TR-55 produced by EMS-Grivory, nylon-6, nylon-12, nylon 6/12, nylon 6/6, and Trogamid® CX by Evonik. If the toughener has a fibrous form, it can be deposited on either surface of a plurality of the reinforcing fibers impregnated by the adhesive composition. The interlayer toughener could further comprise a curable functional group as defined above that reacts with the adhesive composition. The interlayer toughener could be a conductive material or coated with a conductive material or combination of a conductive material and a non-conductive material to regain z-direction electrical and/or thermal conductivity of the cured fiber reinforced polymer composition that was lost by the introduction of the resin-rich interlayers.

Another embodiment of the invention relates to a fiber reinforced polymer composition comprising a reinforcing fiber and an adhesive composition, wherein the adhesive composition comprises at least a thermosetting resin and a curing agent, the curing agent comprises one or more different kinds of curing agents, wherein at least one curing agent comprises at least an amide group, an aromatic group and a curable functional group, and the adhesive composition when cured forms good bonds to the reinforcing fiber.

The reinforcing fiber is required in this embodiment. There are no specific limitations or restrictions on the choice of a reinforcing fiber, as long as the effects of the present invention are not deteriorated. Examples include carbon fibers, organic fibers such as aramid fibers, silicon carbide fibers, metal fibers (e.g., alumina fibers), boron fibers, tungsten carbide fibers, glass fibers, and natural/bio fibers. Carbon fiber in particular is used to provide the cured fiber reinforced polymer composition exceptionally high strength and stiffness as well as light weight. Of all carbon fibers, those with a strength of 2000 MPa or higher, an elongation of 0.5% or higher, and modulus of 200 GPa or higher are preferably used. The form and the arrangement of a plurality of the reinforcing fibers have been discussed previously.

It is required that the adhesive composition, when cured, forms good bonds to the reinforcing fiber. Such reinforcing fiber, in various embodiments of the invention, has a non-polar surface energy at 30° C. of at least 30 mJ/m², at least 40 mJ/m², or even at least 50 mJ/m² and/or a polar surface energy at 30° C. of at least 2 mJ/m², at least 5 mJ/m², or even at least 10 mJ/m². High surface energies are needed to promote wetting of the adhesive composition on the reinforcing fiber. This condition is also necessary to promote good bonds.

In cases when the reinforcing fiber is a carbon fiber, instead of using surface energies as described above for selecting suitable carbon fibers, an interfacial shear strength (IFSS) value of at least 5 MPa, at least 10 MPa, or even at least 15 MPa is used for carbon fiber having a tensile modulus of at least 300 GPa while an IFSS value of at least 20 MPa, at least 25 MPa, or even at least 30 MPa is used for lower modulus carbon fibers. In both cases, however, an O/C concentration of at least 0.05, at least 0.1, or even at least 0.15 is desirable. The oxidized carbon fiber is coated with a sizing material that is chemically reactive with the adhesive composition to improve bonding strengths. Both the O/C concentration on the surface of the carbon fiber and the sizing material collectively are selected to promote adhesion of the adhesive composition to the carbon fiber. There is no restriction on the choice of the sizing material as long as the requirement of surface energies of the carbon fiber is met and/or the sizing promotes good bonds. Ideally, both an observation of failure modes and an IFSS value are needed to confirm good bonds. However, generally, when either observations of failure modes or an IFSS value cannot be obtained, an ILSS value between 14-15 ksi could indicate a mixed mode failure while an ILSS value above 16 ksi could indicate a cohesive failure and an ILSS value between 15-16 ksi could indicate either mixed mode or cohesive failure, depending on the reinforcing fiber and the adhesive composition.

The adhesive composition is also required to have a curing agent comprising at least an amide group, an aromatic group, and a curable functional group to provide good bonding of the epoxy in the cured adhesive composition to the carbon fiber. There are no specific limitations or restrictions on the choice of the amidoamine curing agent and the epoxy as long as the effects of the present invention are not deteriorated. Examples of amidoamine curing agents and epoxy resins were discussed previously. The adhesive composition may further comprise one or more of an interfacial material, a migrating agent, an accelerator, a toughener/filler, and an interlayer toughener. There are no specific limitations or restrictions on the choice of these components as long as the effects of the present invention are not deteriorated. Examples of these components and requirements to form a reinforced interphase were also discussed previously.

Another embodiment of the invention relates to a fiber reinforced polymer composition comprising a carbon fiber having a tensile modulus of at least 300 GPa and an adhesive composition, wherein the adhesive composition is comprised of at least an epoxy resin, an amidoamine curing agent, an interfacial material, and a migrating agent, wherein the epoxy resin, the amidoamine curing agent, the interfacial material and the migrating agent are selected such that the adhesive composition when cured forms good bonds to the reinforcing fiber, and wherein the interfacial material has a gradient in concentration in an interfacial region between the reinforcing fiber and the adhesive composition.

In this embodiment, there are no specific limitations or restrictions on the choice of the carbon fiber having a tensile modulus of at least 300 GPa, the epoxy resin, the amidoamine curing agent, the interfacial material, and the migrating agent as long as the effects of the present invention are not deteriorated. Examples of these components and requirements to form a reinforced interphase were also discussed previously.

The adhesive composition may further comprise one or more of an accelerator, a toughener/filler, and an interlayer toughener. There are no specific limitations or restrictions on the choice of these components as long as the effects of the present invention are not deteriorated. Examples of these components were also discussed previously.

Another embodiment of the invention relates to a fiber reinforced polymer composition comprising a reinforcing fiber and an adhesive composition, wherein the adhesive composition comprises at least a thermosetting resin and an aromatic amidoamine curing agent, and wherein the fiber reinforced polymer composition when cured has an interlaminar shear strength (ILSS) of at least 90 MPa (13 ksi), a tensile strength providing a translation of at least 70%, a compression strength of at least 1380 Mpa (200 ksi), and a mode I fracture toughness of at least 350 J/m² (2 lb·in/in²). To achieve a higher translation than 70% in a cured fiber reinforced polymer composition comprising a reinforcing fiber having a tensile modulus of at least 300 GPa, both good bonds and a resin modulus of higher than 4.0 GPa or even higher than 5 GPa might be needed to alleviate modulus mismatch between the resin and the reinforcing fiber.

In this embodiment, there are no specific limitations or restrictions on the choice of the reinforcing fiber, the thermosetting resin and the aromatic amidoamine curing agent as long as the effects of the present invention are not deteriorated. Examples of these components were also discussed previously.

There are no specific limitations or restrictions on the choice of a method of making a fiber reinforced polymer composition as long as the effects of the present invention are not deteriorated.

In one embodiment, for example, a method of manufacturing a fiber reinforced polymer composition is provided which comprises combining a reinforcing fiber and an adhesive composition, wherein the adhesive composition comprises at least a thermosetting resin and a curing agent, the reinforcing fiber has a tensile modulus of at least 300 GPa, the adhesive composition has a resin modulus of at least 3.2 GPa, and the adhesive composition forms good bonds to the reinforcing fiber when cured.

In another illustrative embodiment, a method of making a fiber reinforced polymer composition is provided which comprises impregnating a reinforcing fiber with an adhesive composition comprised of an epoxy resin, an amidoamine curing agent, a interfacial material and a migrating agent, wherein the epoxy resin, the amidoamine curing agent, the interfacial material and the migrating agent are selected such that the adhesive composition when cured forms good bonds to the reinforcing fiber, wherein the interfacial material has a gradient in concentration in an interfacial region between the reinforcing fiber and the adhesive composition.

Another embodiment relates to a method to create a reinforced interphase in a fiber reinforced polymer composition, wherein a resin infusion method with a low resin viscosity is utilized. In such a case, a migrating agent is concentrated outside a fiber fabric and/or a fiber mat that is stacked to make a desired reform. An adhesive composition comprising at least a thermosetting resin, a curing agent, and an interfacial material is pressurized and infiltrated into the reform, allowing some of the migrating agent to partially mix with the adhesive composition during the infiltration process and penetrate the reform. By having some of the migrating agent in the adhesive composition, the reinforced interphase could be formed during cure of the fiber reinforced polymer composition. The remainder of the migrating agent is concentrated in the interlayer between two fabric sheets or mats and could improve the impact and damage resistance of the fiber reinforced polymer composition. Thermoplastic particles with an average size less than 50 μm could be used as the migrating agent. Examples of such thermoplastic materials include but are not limited to polysulfones, polyethersulfones, polyamides, polyamideimides, polyimides, polyetherimides, polyetherketones, and polyetheretherketones, their derivatives, similar polymers, and mixtures thereof.

The fiber reinforced polymer compositions of the present invention may, for example, be heat-curable or curable at room temperature. In another embodiment, the aforementioned fiber reinforced polymer compositions can be cured by a one-step cure to a final cure temperature, or a multiple-step cure in which the fiber reinforced polymer composition is dwelled (maintained) at a certain dwell temperature for a certain period of dwell time to allow an interfacial material in the fiber reinforced polymer composition to migrate onto the reinforcing fiber's surface, and ramped up and cured at the final cure temperature for a desired period of time. The dwell temperature could be in a temperature range in which the adhesive composition has a low viscosity. The dwell time could be at least about five minutes. The final cure temperature of the adhesive resin composition could be set after the adhesive resin composition reaches a degree of cure of at least 20% during the ramp up. The final cure temperature could be about 220° C. or less, or about 180° C. or less. The fiber reinforced polymer composition could be kept at the final cure temperature until a degree of cure reaches at least 80%. Vacuum and/or external pressure could be applied to the reinforced polymer composition during cure. Examples of these methods include autoclave, vacuum bag, pressure-press (i.e., one side of the article to be cured contacts a heated tool's surface while the other side is under pressurized air with or without a heat medium), or a similar method. Note that other curing methods using an energy source other than thermal, such as electron beam, conduction method, microwave oven, or plasma-assisted microwave oven, or combination could be applied. In addition, other external pressure methods such as shrink wrap, bladder blowing, platens, or table rolling could be used.

For fiber reinforced polymer composites, one embodiment of the present invention relates to a manufacturing method to combine fibers and resin matrix to produce a curable fiber reinforced polymer composition (sometimes referred to as a “prepreg”) which is subsequently cured to produce a composite article. Employable is a wet method in which fibers are soaked in a bath of the resin matrix dissolved in a solvent such as methyl ethyl ketone or methanol, and withdrawn from the bath to remove solvent.

Another suitable method is a hot melt method, where the epoxy resin composition is heated to lower its viscosity, directly applied to the reinforcing fibers to obtain a resin-impregnated prepreg; or alternatively, as another method, the epoxy resin composition is coated on a release paper to obtain a thin film. The film is consolidated onto both surfaces of a sheet of reinforcing fibers by heat and pressure.

To produce a composite article from the prepreg, for example, one or more plies are applied onto a tool surface or mandrel. This process is often referred to as tape-wrapping. Heat and pressure are needed to laminate the plies. The tool is collapsible or removed after cured. Curing methods such as autoclave and vacuum bag in an oven equipped with a vacuum line could be used. A one-step cure cycle or multiple-step cure cycle in that each step is performed at a certain temperature for a period of time could be used to reach a cure temperature of about 220° C. or even 180° C. or less. However, other suitable methods such as conductive heating, microwave heating, electron beam heating and similar methods, can also be employed. In an autoclave method, pressure is provided to compact the plies, while a vacuum-bag method relies on the vacuum pressure introduced to the bag when the part is cured in an oven. Autoclave methods could be used for high quality composite parts. In other embodiments, any methods that provide suitable heating rates of at least 0.5° C./min, at least 1° C./min, at least 5° C./min, or even at least 10° C./min and vacuum and/or compaction pressures by an external means could be used.

Without forming prepregs, the adhesive composition may be directly applied to reinforcing fibers which are conformed onto a tool or mandrel for a desired part's shape, and cured under heat. The methods include, but are not limited to, filament-winding, pultrusion molding, resin injection molding and resin transfer molding/resin infusion, vacuum assisted resin transfer molding.

The resin transfer molding method is a method in which a reinforcing fiber base material is directly impregnated with a liquid thermosetting resin composition and cured. Since this method does not involve an intermediate product, such as a prepreg, it has great potential for molding cost reduction and is advantageously used for the manufacture of structural materials for spacecraft, aircraft, rail vehicles, automobiles, marine vessels and so on.

The filament winding method is a method in which one to several tens of reinforcing fiber rovings are drawn together in one direction and impregnated with a thermosetting resin composition as they are wrapped around a rotating metal core (mandrel) under tension at a predetermined angle. After the wraps of rovings reach a predetermined thickness, it is cured and then the metal core is removed.

The pultrusion method is a method in which reinforcing fibers are continuously passed through an impregnating tank filled with a liquid thermosetting resin composition to impregnate them with the thermosetting resin composition, followed by a squeeze die and heating die for molding and curing, by continuously drawing them using a tensile machine. Since this method offers the advantage of continuously molding fiber-reinforced composite materials, it is used for the manufacture of reinforcement fiber fiber-reinforced plastics (FRPs) for fishing rods, rods, pipes, sheets, antennas, architectural structures, and so on.

Composite articles in the invention are advantageously used in sports applications, general industrial applications, and aerospace and space applications. Concrete sports applications in which these materials are advantageously used include golf shafts, fishing rods, tennis or badminton rackets, hockey sticks and ski poles. Concrete general industrial applications in which these materials are advantageously used include structural materials for vehicles, such as automobiles, bicycles, marine vessels and rail vehicles, drive shafts, leaf springs, windmill blades, pressure vessels, flywheels, papermaking rollers, roofing materials, cables, and repair/reinforcement materials.

Tubular composite articles in the invention are advantageously used for golf shafts, fishing rods, and the like.

### Examination of a Reinforced Interphase

For visual inspection, a high magnification optical microscope or a scanning electron microscope (SEM) could be used to document the failure modes and location/distribution of an interfacial material. The interfacial material could be found on the surface of the fiber along with the adhesive composition after the bonded structure fails. In such cases, mixed mode failure or cohesive failure of the adhesive composition is possible. Good particle migration refers to about 50% or more coverage of the particles on the fiber surface (herein referred to as “particle coverage”), no particle migration refers to less than about 5% coverage, and some particle migration refers to about 5-50% coverage. While a particle coverage of at least 50% is needed to simultaneously improve a wide range of mechanical properties of the fiber reinforced polymer composites, in some cases a particle coverage of at least 10% or even at least 20% is suitable to improve some certain desired properties.

Several methods are known to one skilled in the art to examine and locate the presence of the interfacial material through thickness. An example is to cut the composite structure at 90°, 45° with respect to the fiber's direction. The cut cross-section is polished mechanically or by an ion beam such as argon, and examined under a high magnification optical microscope or electron microscope. SEM is one possible method. Note that in the case where SEM cannot observe the interphase, other available state-of-the-art instruments could be used to document the existence of the interphase and its thickness through another electron scanning method such as TEM, chemical analyses (e.g., X-ray photoelectron spectroscopy (XPS), Time-of-Flight Secondary Ion Mass Spectrometry (ToF-SIMS), infrared (IR) spectroscopy, Raman, the alike or similar) or mechanical properties (e.g., nanoindentation, atomic force microscopy (AFM)), or a similar method.

An interfacial region or an interphase where the interfacial material is concentrated can be observed and documented. The interphase is typically measured from the fiber's surface to a definite distance away where the interfacial material is no longer concentrated compared to the concentration of the interfacial material in the surrounding resin-rich areas. Depending on the amount of the cured adhesive found between two fibers, the interphase could be extended up to 100 micrometers, comprising one or more layers of the interfacial material of one or more different kinds. In an embodiment of the invention, the interphase thickness could be up to about 1 fiber diameter, comprising one or more layers of the interfacial material of one or more different kinds. The thickness could be up to about ½ of the fiber diameter.

### EXAMPLES

Next, certain embodiments of the invention are illustrated in detail by means of the following examples using the following components:

| Component | Product name | Manufacturer | Description |
|---|---|---|---|
| Epoxy | ELM434 | Sumitomo | Tetra glycidyl diamino diphenyl |
| | | Chemical Co., | methane with a functionality of 4, |
| | | Ltd. | having an average EEW of 120 |
| | | | (ELM434) |
| | Epon ® 828 | Momentive | Difunctional bisphenol A/ |
| | | Specialty | epichlorohydrin, having an average |
| | | Chemicals | EEW of 188 (EP828) |
| | Epon ® 825 | Momentive | Diglycidyl ether of bisphenol A with a |
| | | | functionality of 2, having an average |
| | | | EEW of 177 (EP25) |
| | Epiclon ® 830 | Dainippon Ink | Diglycidyl ether of bisphenol F with a |
| | | and Chemicals, | functionality of 2, having an average |
| | | Inc. | EEW of 177 (EPc830) |
| | Epon ® 2005 | Momentive | Diglycidyl ether of bisphenol A with a |
| | | | functionality of 2, having an average |
| | | | EEW of 1300 (EP2005) |
| | Araldite ® EPN 1138 | Huntsman | Epoxy phenol novolac with a |
| | | Advanced | functionality of 3.6 and having an |
| | | Materials | average EEW of 179 (EPN1138) |
| | D.E.N. ™ 439 | The Dow | Epoxy novolac, epichlorohydrin and |
| | | Chemical | phenol-formaldehyde novolac with a |
| | | Company | functionality of 3.8 and having an |
| | | | average EEW of 200 (DEN439) |
| Migrating | Sumikaexcel ® | Sumitomo | Polyethersulfone, MW 38,200 (PES1) |
| agent | PES5003P | Chemical Co., | |
| | | Ltd. | |
| | VW-10700RP | Solvay | Polyethersulfone, MW 21,000 (PES2) |
| | Ultem ® 1000P | Sabic | Polyetherimide (PEI) |
| | Vinylec ™ type K | Chisso | Polyvinyl formal (PVF) |
| | | Corporation | |
| Thermoplastic | Grilamid TR55 | EMS-Grivory | Polyamide (PA) |
| particle | | | |
| Curing agent | ARADUR 9664-1 | Huntsman | 4,4′-diaminodiphenyl sulfone (DDS) |
| | | Advanced | |
| | | Materials | |
| | Anthranilamide | Sigma Aldrich | 2-Aminobenzamide or anthranilamide |
| | | | (AAA) |
| | Sulfanilamide | Sigma Aldrich | p-Aminobenzenesulfonamide (SAA) |
| | 4,4′- | Sigma Aldrich | 4,4′-Diaminobenzanilide (DABA) |
| | Diaminobenzanilide | | |
| | 4-Aminobenzamide | Sigma Aldrich | 4-Aminobenzamide (4-ABA) |
| | Dyhard ® 100S | Alz Chem | Dicyandiamide (DICY) |
| | | Trostberg GmbH) | |
| Accelerator | Dyhard ® UR200 | Alz Chem | 3-(3,4-dichlorophenyl)-1,1-dimethyl |
| | | Trostberg GmbH | urea (UR200) |
| Interfacial | Kane Ace MX416 | Kaneka Texas | 25 wt % core-shell rubber (CSR) |
| material | | Corporation | particles having core composition of |
| | | | polybutadiene (CSR) in epoxy |
| | T700GC-12K-31E | Toray Industries, | 12,000 fibers, tensile strength 4.9 GPa, |
| | | Inc. | tensile modulus 240 GPa, tensile strain |
| | | | 2.0%, density 1.80 g/cm³, type-3 |
| | | | sizing for epoxy resin systems |
| | | | (T700G-31) |
| | T700GC-12K-51C | Toray Industries, | 12,000 fibers, tensile strength 4.9 GPa, |
| | | Inc. | tensile modulus 240 GPa, tensile strain |
| | | | 2.0%, density 1.80 g/cm³, type-5 |
| | | | sizing for epoxy, phenolic, polyester, |
| | | | vinyl ester resin systems (T700G-51) |
| | MX-12K-10E | Toray Industries, | 12,000 fibers, tensile strength 4.9 GPa, |
| | | Inc. | tensile modulus 370 GPa, tensile strain |
| | | | 1.2%, density 1.77 g/cm³, type-1 |
| | | | sizing for epoxy resin systems (MX- |
| | | | 10) |
| | MX-12K-30E | Toray Industries, | 12,000 fibers, tensile strength 4.9 GPa, |
| | | Inc. | tensile modulus 370 GPa, tensile strain |
| | | | 1.2%, density 1.77 g/cm³, type-3 sizing |
| | | | for epoxy resin systems (MX-30) |
| | MX-12K-50E | Toray Industries, | 12,000 fibers, tensile strength 4.9 GPa, |
| | | Inc. | tensile modulus 370 GPa, tensile strain |
| | | | 1.2%, density 1.77 g/cm³, type-5 |
| | | | sizing for epoxy, phenolic, polyester, |
| | | | vinyl ester resin systems (MX-50) |
| | M40JB-6K-30B | Toray Industries, | 6,000 fibers, tensile strength 4.4 GPa, |
| | | Inc. | tensile modulus 370 GPa, tensile strain |
| | | | 1.2%, density 1.77 g/cm³, type-3 |
| | | | sizing for epoxy resin systems (M40J- |
| | | | 30) |
| | M40JB-6K-50B | Toray Industries, | 6,000 fibers, tensile strength 4.4 GPa, |
| | | Inc. | tensile modulus 370 GPa, tensile strain |
| | | | 1.2%, density 1.77 g/cm³, type-5 |
| | | | sizing for epoxy, phenolic, polyester, |
| | | | vinyl ester resin systems (M40J-50) |

MX fibers were made using a similar PAN precursor in a similar spinning process as T800S fibers. However, to obtain a higher modulus, up to a maximum carbonization temperature of 3000° C. could be applied. For surface treatment and sizing application, similar processes were utilized. For these MX fibers, a ratio of oxygen to carbon was found to be about 0.1.

### Examples 1-8 and Comparative Examples 1-4

Examples 1-8 and Comparative Examples 1-4, where Comparative Examples 1-4 are the respective controls or the current-state-of-the-art systems, show the effects of a high resin modulus and adhesion on properties of high modulus carbon fiber composites. High modulus carbon fibers MX and M40J with different surface chemistry are used.

Appropriate amounts of thermosetting resins and additives of an adhesive composition as shown in Table 1 were charged into a mixer preheated at 100° C. After charging, the temperature was increased to 160° C. while the mixture was agitated, and held for 1 hr. After that, the mixture was cooled to 65° C. and the curing agent and the accelerator were charged. The final resin mixture was agitated for 1 hr, then discharged and some was stored in a freezer.

Some of the hot mixture was degassed in a planetary mixer rotating at 1500 rpm for a total of 20 min, and poured into a metal mold with 0.25 in thick Teflon® insert. The resin was heated to 180° C. with the ramp rate of 1.7° C./min, allowed to dwell for 2 hr to complete curing, and finally cooled down to room temperature. Resin plates were prepared for testing according to ASTM D-790 for flexural test.

To make a prepreg, the hot resin was first cast into a thin film using a knife coater onto a release paper. The film was consolidated onto a bed of fibers on both sides by heat and compaction pressure. A UD prepreg having a carbon fiber area weight of about 190 g/m² and resin content of about 35% was obtained. The prepregs were cut and hand laid up with the sequence listed in Table 2 for each type of mechanical test, followed an ASTM procedure. Panels were cured in an autoclave at 180° C. for 2 hr with a ramp rate of 1.7° C./min and a pressure of 0.59 MPa. Alternatively, a dwell at about 90° C. for about 45 min could be introduced to promote particle migration when needed before ramping up to 180° C.

As shown, Example 1 with the curing agent AAA provided a significant improvement in resin modulus without significantly penalizing flexural deflection, compared to its respective Comparative Example 1 with the curing agent DICY and compared to Comparative Example 2 with DICY but different epoxies. In addition, adhesion measured by ILSS for this system was significantly increased though mixed mode failure occurred, as opposed to the adhesive failure observed in Comparative Examples 1-2 and therefore, much lower ILSS values were obtained. Furthermore, due to higher adhesion and resin modulus without penalizing much strain, both tensile and compressive strength were increased in this system, respectively. Similar effects were observed in Examples 2-4 with an isomer of the AAA curing agent (4ABA) and other aromatic amidoamine curing agents (SAA, DABA). It was also found that an accelerator (UR200) can be used with these amidoamines without degrading mechanical properties.

Similarly, the curing agent AAA used in Examples 5-8 showed great advantages over the curing agent DDS used in Comparative Examples 3-4 in that ILSS, compression strength, and tensile strength simultaneously increased. Surprisingly, when the AAA-based resin system was combined with MX-30 or M40J-30 fibers (Examples 6-8), cohesive failure mode was observed. As a result, ILSS was dramatically increased up to 17 ksi (Example 6). Surface energy by IGC for these fibers revealed a non-polar surface energy at 30° C. of about 35 mJ/m². Furthermore, when interlayer tougheners particles (PA) were introduced into Example 6 to create Example 8, mode II fracture toughness was increased significantly without penalizing other properties observed in Example 6.

The above results were surprising, in that the studied aromatic amidoamines combined with specific fiber surface chemistries ultimately solved the adhesion problem in high modulus carbon fiber composites.

### Examples 9-13 and Comparative Example 5-6

These examples explored the possibility of further improving bonding of an adhesive composition to a high modulus carbon fiber by incorporating an interfacial material in the previously studied systems. Resins, prepreg and composite mechanical tests were performed using procedures as in previous examples.

The interfacial material CSR was incorporated into Examples 1, 5 to create Examples 9-10. In these cases, a reinforced interphase was formed. With the interphase, failure mode was changed from mixed modes (Examples 1, 5) to cohesive failures (Examples 9-10) in the interphase, indicating better bonds were formed between the resin and the fiber. Compared to their respective systems (Comparative Examples 5-6), on top of the previously observed effects the interphase (presumably comprising at least the interfacial material, functional groups on the fiber surface and amidoamines) led to a significant improvement in mode I fracture toughness. The curing agent AAA was rationalized to be responsible for the results. Examples 11-13 explored different ways to create a reinforced interphase by changing the fiber surface chemistry to MX-30 (Example 11), changing the migrating agent to PEI (Example 12) and reducing the amount of the curing agent AAA (Example 12). In all cases, a reinforced interphase was formed, leading to similar results as those in Examples 9-10.

### Examples 14-18 and Comparative Examples 7-8

Resins, prepreg and composite mechanical tests were performed using procedures as in previous examples.

Examples 14-18 were tailored to confirm the effects of AAA over DDS and DICY in Comparative Examples 7-8 (controls). A standard modulus carbon fiber T700G-31 was used.

Significant improvements on ILSS and compression were observed as seen in previous cases with high modulus fibers. Yet, surprisingly, tensile strength was improved up to 100% translation and mode I fracture toughness was increased up to 300%, especially when a reinforced interphase was formed (Examples 15-18). These remarkable improvements were not observed in the high modulus carbon fiber systems. It was rationalized that a higher modulus resin system might be needed in these high modulus carbon fiber systems.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations. The numerical ranges disclosed inherently support any range within the disclosed numerical ranges though a precise range limitation is not stated verbatim in the specification because this invention can be practiced throughout the disclosed numerical ranges. Finally, the entire disclosures of the patents and publications referred in this application are hereby incorporated herein by reference.

TABLE 1

| | | | Example | | | | | | | | | | | | |
|---|---|---|---|---|---|---|---|---|---|---|---|---|---|---|---|
| | | | 1 | 2 | 3 | 4 | 5 | 6 | 7 | 8 | 9 | 10 | 11 | 12 | 13 |
| Resin | Epoxy | ELM434 | 60 | 60 | 60 | 60 | 60 | 60 | 60 | 60 | 60 | 60 | 60 | 60 | 60 |
| matrix | | EPON825 | 20 | 20 | 20 | 20 | 20 | 20 | 20 | 20 | 20 | 20 | 20 | 0 | 20 |
| compo- | | EPc830 | 10 | 10 | 10 | 10 | 10 | 10 | 10 | 10 | 10 | 10 | 10 | 0 | 10 |
| sition | | EPON2005 | 10 | 10 | 10 | 10 | 10 | 10 | 10 | 10 | 10 | 10 | 10 | 0 | 10 |
| (phr) | | EP828 | 0 | 0 | 0 | 0 | 0 | 0 | 0 | 0 | 0 | 0 | 0 | 0 | 0 |
| | | DEN439 | 0 | 0 | 0 | 0 | 0 | 0 | 0 | 0 | 0 | 0 | 0 | 30 | 0 |
| | | EPN1138 | 0 | 0 | 0 | 0 | 0 | 0 | 0 | 0 | 0 | 0 | 0 | 10 | 0 |
| | Curing | DDS | 0 | 0 | 0 | 0 | 0 | 0 | 0 | 0 | 0 | 0 | 0 | 0 | 0 |
| | agent | AAA | 31 | 0 | 0 | 0 | 31 | 31 | 31 | 31 | 31 | 31 | 31 | 32 | 25 |
| | | 4ABA | 0 | 31 | 0 | 0 | 0 | 0 | 0 | 0 | 0 | 0 | 0 | 0 | 0 |
| | | SAA | 0 | 0 | 31 | 0 | 0 | 0 | 0 | 0 | 0 | 0 | 0 | 0 | 0 |
| | | DABA | 0 | 0 | 0 | 56 | 0 | 0 | 0 | 0 | 0 | 0 | 0 | 0 | 0 |
| | | DICY | 0 | 0 | 0 | 0 | 0 | 0 | 0 | 0 | 0 | 0 | 0 | 0 | 0 |
| | Accelerator | UR200 | 3 | 0 | 0 | 0 | 0 | 0 | 0 | 0 | 0 | 0 | 0 | 3 | 0 |
| | Interfacial | CSR | 0 | 0 | 0 | 0 | 0 | 0 | 0 | 0 | 5 | 5 | 5 | 5 | 5 |
| | material | | | | | | | | | | | | | | |
| | Migrating | PES1 | 0 | 9 | 9 | 9 | 0 | 0 | 0 | 8 | 0 | 0 | 0 | 0 | 0 |
| | agent | PES2 | 12 | 0 | 0 | 0 | 12 | 12 | 12 | 0 | 12 | 12 | 0 | 14 | 12 |
| | | PEI | 0 | 0 | 0 | 0 | 0 | 0 | 0 | 0 | 0 | 0 | 9 | 0 | 0 |
| | | PVF | 0 | 0 | 0 | 0 | 0 | 0 | 0 | 0 | 0 | 0 | 0 | 0 | 0 |
| | Optional | PA | 0 | 0 | 0 | 0 | 0 | 0 | 0 | 30 | 0 | 0 | 0 | 0 | 0 |
| Fiber | Type-1 | MX-10 | 0 | 0 | 0 | 0 | 100 | 0 | 0 | 0 | 0 | 100 | 0 | 0 | 0 |
| (wt %) | sizing | | | | | | | | | | | | | | |
| | Type-3 | MX-30 | 0 | 0 | 0 | 0 | 0 | 100 | 0 | 100 | 0 | 0 | 100 | 100 | 100 |
| | sizing | T700G-31 | 0 | 0 | 0 | 0 | 0 | 0 | 0 | 0 | 0 | 0 | 0 | 0 | 0 |
| | | M40J-30 | 0 | 0 | 0 | 0 | 0 | 0 | 100 | 0 | 0 | 0 | 0 | 0 | 0 |
| | Type-5 | MX-50 | 100 | 100 | 100 | 100 | 0 | 0 | 0 | 0 | 100 | 0 | 0 | 0 | 0 |
| | sizing | M40J-50 | 0 | 0 | 0 | 0 | 0 | 0 | 0 | 0 | 0 | 0 | 0 | 0 | 0 |
| | | T700G-51 | 0 | 0 | 0 | 0 | 0 | 0 | 0 | 0 | 0 | 0 | 0 | 0 | 0 |
| Prepreg | Resin content, wt % | | 37 | 37 | 37 | 37 | 38 | 38 | 37 | 38 | 38 | 37 | 36 | 37 | 37 |
| | Fiber area weight, gm² | | 190 | 190 | 190 | 190 | 190 | 190 | 190 | 190 | 190 | 190 | 190 | 190 | 190 |
| Cured resin | Flexure modulus @ RTD (GPa) | | 4.7 | 3.8 | 4.5 | 4.4 | 4.7 | 4.7 | 4.7 | 4.5 | 4.3 | 4.3 | 4.3 | 4.5 | 4.1 |
| | Flexural deflection (mm) | | 4.2 | 5.3 | 4.4 | 4.6 | 4.2 | 4.2 | 4.2 | 4.3 | 5.5 | 5.5 | 5.5 | 5.5 | 6.0 |
| Composite | Tension* | Strength (ksi) | 297 | 275 | 289 | 290 | 286 | 270 | 255 | 265 | 262 | 270 | 300 | 275 | 284 |
| | | Translation** | 77 | 72 | 75 | 76 | 76 | 72 | 74 | 70 | 70 | 70 | 77 | 72 | 74 |
| | | (%) | | | | | | | | | | | | | |
| | Fracture | G_{IC} (lb · in/in²) | 2.4 | | | | 2.6 | 2.8 | | | 2.9 | 2.8 | 3.8 | 3.2 | 3.6 |
| | toughness | G_{IIC} (lb · in/in²) | 3.7 | | | | | | | 10 | | | | | |
| | Good bond | Failure mode | M | M | M | M | M | C | C | C | C | C | C | C | C |
| | | (A: adhesive, | | | | | | | | | | | | | |
| | | C: Cohesive, | | | | | | | | | | | | | |
| | | M: mixed mode) | | | | | | | | | | | | | |
| | | ILSS (ksi) | 15.7 | 15.0 | 14.8 | 14.6 | 15.5 | 17.0 | 16.5 | 16.0 | 16.3 | 16.0 | 17.4 | 16.0 | 16.1 |
| | Compression* | Ultimate | 211 | 205 | 200 | 201 | 210 | 222 | 210 | 222 | 210 | 200 | 225 | 203 | 200 |
| | | strength (ksi) | | | | | | | | | | | | | |

| | | |
|---|---|---|
| C.E. | Example | C.E. |

| | | | 1 | 2 | 3 | 4 | 5 | 6 | 14 | 15 | 16 | 17 | 18 | 7 | 8 |
|---|---|---|---|---|---|---|---|---|---|---|---|---|---|---|---|
| Resin | Epoxy | ELM434 | 60 | 0 | 60 | 60 | 60 | 60 | 60 | 60 | 60 | 60 | 60 | 60 | 10 |
| matrix | | EPON825 | 20 | 15 | 30 | 30 | 30 | 30 | 0 | 0 | 0 | 20 | 20 | 0 | 0 |
| compo- | | EPc830 | 10 | 0 | 10 | 10 | 10 | 10 | 0 | 0 | 0 | 10 | 10 | 0 | 0 |
| sition | | EPON2005 | 10 | 5 | 0 | 0 | 0 | 0 | 0 | 0 | 0 | 10 | 10 | 0 | 30 |
| (phr) | | EP828 | 0 | 0 | 0 | 0 | 0 | 0 | 0 | 0 | 0 | 0 | 0 | 0 | 60 |
| | | DEN439 | 0 | 0 | 0 | 0 | 0 | 0 | 30 | 30 | 30 | 0 | 0 | 30 | 0 |
| | | EPN1138 | 0 | 80 | 0 | 0 | 0 | 0 | 10 | 10 | 10 | 0 | 0 | 10 | 0 |
| | Curing | DDS | 0 | 0 | 45 | 45 | 45 | 45 | 0 | 0 | 0 | 0 | 0 | 45 | 0 |
| | agent | AAA | 0 | 0 | 0 | 0 | 0 | 0 | 32 | 32 | 32 | 0 | 0 | 0 | 0 |
| | | 4ABA | 0 | 0 | 0 | 0 | 0 | 0 | 0 | 0 | 0 | 0 | 0 | 0 | 0 |
| | | SAA | 0 | 0 | 0 | 0 | 0 | 0 | 0 | 0 | 0 | 31 | 0 | 0 | 0 |
| | | DABA | 0 | 0 | 0 | 0 | 0 | 0 | 0 | 0 | 0 | 0 | 33 | 0 | 0 |
| | | DICY | 5 | 5 | 0 | 0 | 0 | 0 | 0 | 0 | 0 | 0 | 0 | 0 | 4 |
| | Accelerator | UR200 | 3 | 3 | 0 | 0 | 0 | 0 | 3.5 | 3.5 | 0 | 0 | 0 | 3.5 | 3.5 |
| | Interfacial | CSR | 0 | 0 | 0 | 0 | 5 | 5 | 0 | 5 | 5 | 5 | 5 | 0 | 0 |
| | material | | | | | | | | | | | | | | |
| | Migrating | PES1 | 0 | 0 | 6 | 6 | 0 | 0 | 0 | 0 | 0 | 6 | 6 | 0 | 0 |
| | agent | PES2 | 12 | 0 | 0 | 0 | 12 | 12 | 14 | 14 | 0 | 0 | 0 | 14 | 0 |
| | | PEI | 0 | 0 | 0 | 0 | 0 | 0 | 0 | 0 | 9 | 0 | 0 | 0 | 0 |
| | | PVF | 0 | 8 | 0 | 0 | 0 | 0 | 0 | 0 | 0 | 0 | 0 | 0 | 5 |
| | Optional | PA | 0 | 0 | 0 | 0 | 0 | 0 | 0 | 0 | 0 | 0 | 0 | 0 | 0 |
| Fiber | Type-1 | MX-10 | 0 | 0 | 100 | 0 | 0 | 100 | 0 | 0 | 0 | 0 | 0 | 0 | 0 |
| (wt %) | sizing | | | | | | | | | | | | | | |
| | Type-3 | MX-30 | 0 | 0 | 0 | 100 | 0 | 0 | 0 | 0 | 0 | 0 | 0 | 0 | 0 |
| | sizing | T700G-31 | 0 | 0 | 0 | 0 | 0 | 0 | 100 | 100 | 100 | 0 | 0 | 100 | 100 |
| | | M40J-30 | 0 | 0 | 0 | 0 | 0 | 0 | 0 | 0 | 0 | 0 | 0 | 0 | 0 |
| | Type-5 | MX-50 | 100 | 0 | 0 | 0 | 100 | 0 | 0 | 0 | 0 | 0 | 0 | 0 | 0 |
| | sizing | M40J-50 | 0 | 100 | 0 | 0 | 0 | 0 | 0 | 0 | 0 | 0 | 0 | 0 | 0 |
| | | T700G-51 | 0 | 0 | 0 | 0 | 0 | 0 | 0 | 0 | 0 | 100 | 100 | 0 | 0 |
| Prepreg | Resin content, wt % | | 33 | 34 | 38 | 35 | 34 | 36 | 32 | 33 | 32 | 33 | 33 | 32 | 33 |
| | Fiber area weight, gm² | | 190 | 190 | 190 | 190 | 190 | 190 | 150 | 150 | 150 | 190 | 190 | 150 | 150 |
| Cured resin | Flexure modulus @ RTD (GPa) | | 3.5 | 3.5 | 3.2 | 3.2 | 3.1 | 3.1 | 4.7 | 4.3 | 4.3 | 4.1 | 4.2 | 3.2 | 3.5 |
| | Flexural deflection (mm) | | 5.8 | 6.0 | 6.0 | 6.0 | 6.5 | 6.5 | 4.5 | 5.5 | 5.5 | 4.1 | 4.0 | 6.5 | 6.0 |
| Composite | Tension* | Strength (ksi) | 252 | 270 | 220 | 267 | 290 | 240 | 385 | 410 | 405 | 380 | 395 | 365 | 335 |
| | | Translation** | 61 | 74 | 58 | 67 | 71 | 61 | 92 | 100 | 97 | 92 | 96 | 87 | 81 |
| | | (%) | | | | | | | | | | | | | |
| | Fracture | G_{IC} (lb · in/in²) | 1.6 | 1.8 | 1.4 | 1.1 | 1.4 | 2.1 | 2.9 | 4.6 | 4.2 | 4 | 4.2 | 2.5 | 1.5 |
| | toughness | G_{IIC} (lb · in/in²) | 4 | 4.2 | | | 3.6 | 3.4 | | | | | | | |
| | Good bond | Failure mode | A | A | A | A | M | M | C | C | C | C | C | C | M |
| | | (A: adhesive, | | | | | | | | | | | | | |
| | | C: Cohesive, | | | | | | | | | | | | | |
| | | M: mixed mode) | | | | | | | | | | | | | |
| | | ILSS (ksi) | 12.4 | 12.1 | 13.5 | 14.5 | 14.5 | 14.0 | 15.9 | 15.6 | 15.2 | 15.0 | 15.0 | 14.5 | 13.5 |
| | Compression* | Ultimate | 188 | 190 | 181 | 178 | 175 | 178 | 216 | 232 | 230 | 220 | 222 | 191 | 201 |
| | | strength (ksi) | | | | | | | | | | | | | |

*Normalized to V_{f} = 60%
**Estimated based on resin content and fiber area weight. Resin density is about 1.22 g/cm³

TABLE 2

| | | Panel Size | Ply Lay-up | Test |
|---|---|---|---|---|
| Test Panel | Test method | (mm × mm) | Configuration | Condition |
| 0deg-Tensile | ASTM D 3039 | 300 × 300 | (0)₆ | RTD |
| Compression | ASTM D | 300 × 300 | (0)₆ | RTD |
| strength | 695/ASTM | | | |
| | D 3410 | | | |
| ILSS | ASTM D-2344 | 300 × 300 | (0)₁₂ | RTD |
| DCB | ASTM D 5528 | 350 × 300 | (0)₂₀ | RTD |
| ( for G_{IC}) | | | | |
| 0°/90° | ASTM D 790 | 300 × 300 | (0)₁₂ | RTD |
| Flexure | | | | |
| ENF | JIS K 7086* | 350 × 300 | (0)₂₀ | RTD |
| (for G_{IIC}) | | | | |

*Japanese Industrial Standard Test Procedure

Translation Factor.

Percent translation is a measure of how effectively fiber's strength is utilized in a fiber reinforced polymer composite. It was calculated from the equation below, where a measured tensile strength (TS) is normalized by a measured strand strength of fibers and fiber volume fracture (V_{f}) in the fiber reinforced polymer composite. Note that V_{f} can be determined from an acid digestion method.

$$\% translation = \frac{T S}{Strand strength \times {V}_{f}} \times 100$$

1. A fiber reinforced polymer composition comprising a reinforcing fiber and an adhesive composition, wherein the adhesive composition comprises at least a thermosetting resin and a curing agent, the reinforcing fiber has a tensile modulus of at least 300 GPa, the adhesive composition has a resin modulus of at least 3.2 GPa, and the adhesive composition forms good bonds to the reinforcing fiber when cured.

2. The fiber reinforced polymer composition of claim 1, wherein the curing agent comprises at least an amide group and at least one aromatic group.

3. The fiber reinforced polymer composition of claim 2, wherein the curing agent further comprises at least one curable functional group selected from a nitrogen-containing group, a hydroxyl group, a carboxylic acid group, or an anhydride group.

4. The fiber reinforced polymer composition of claim 3, wherein the nitrogen-containing group comprises an amine group.

5. The fiber reinforced polymer composition of claim 4, wherein the curing agent comprises an aminobenzamide, a diaminobenzanilide, an aminobenzenesulfonamide, aminoterephthalamide, a derivative thereof, an isomer thereof, or a mixture thereof.

6. (canceled)

7. The fiber reinforced polymer composition of claim 65, wherein the adhesive composition further comprises an interfacial material and a migrating agent, wherein the interfacial material is concentrated in-situ in an interfacial region between the adhesive composition and the reinforcing fiber during curing of the thermosetting resin such that the interfacial material has a gradient in concentration in the interfacial region, wherein the interfacial material has a higher concentration in a vicinity of the reinforcing fiber than further away from the reinforcing fiber.

8. (canceled)

9. The fiber reinforced polymer composition of claim 87, wherein the adhesive composition further comprises at least one of an accelerator, a toughener, an interlayer toughener, or a combination thereof.

10. A fiber reinforced polymer composition comprising a reinforcing fiber and an adhesive composition, wherein the adhesive composition comprises at least a thermosetting resin comprising an epoxy resin and a curing agent, the curing agent comprises one or more different kinds of curing agents, wherein at least one curing agent comprises at least an amide group, an aromatic group and a curable functional group, and the adhesive composition when cured forms good bonds to the reinforcing fiber.

11. The fiber reinforced polymer composition of claim 10, wherein the curing agent comprises an aminobenzamide, an aminoterephthalamide, a diaminobenzanilide, an aminobenzenesulfonamide, a derivative thereof, an isomer thereof, or a combination thereof.

12. (canceled)

13. The fiber reinforced polymer composition of claim 11, wherein the adhesive composition further comprises an interfacial material and a migrating agent, the interfacial material is concentrated in-situ in an interfacial region between the adhesive composition and the reinforcing fiber during curing of the thermosetting resin such that the interfacial material has a gradient in concentration in the interfacial region, and the interfacial material has a higher concentration in a vicinity of the reinforcing fiber than further away from the reinforcing fiber.

14. (canceled)

15. The fiber reinforced polymer composition of claim 13, wherein the adhesive composition further comprises at least one of an accelerator, a toughener, an interlayer toughener, or a combination thereof.

16. The fiber reinforced polymer composition of claim 1, wherein the reinforcing fiber is a carbon fiber.

17. The fiber reinforced polymer composition of claim 1, wherein the reinforcing fiber is a carbon fiber having a surface which has been treated to increase the concentration of oxygen functional groups on the surface, wherein the treated surface has a ratio of oxygen to carbon of at least 0.05.

18. The fiber reinforced polymer composition of claim 1, wherein the reinforcing fiber is a carbon fiber having a surface which has been treated with a sizing, wherein the sized surface has a non-polar surface energy at 30° C. of at least 30 mJ/m²

19. A prepreg comprising the fiber reinforced polymer composition of claim 1.

20. (canceled)

21. (canceled)

22. A method of manufacturing a composite article comprising curing the fiber reinforced polymer composition of claim 1.

23. (canceled)

24. (canceled)

25. A fiber reinforced polymer composition comprising a carbon fiber having a tensile modulus of at least 300 GPa and an adhesive composition, wherein the adhesive composition is comprised of at least an epoxy resin, an amidoamine curing agent, an interfacial material, and a migrating agent, wherein the epoxy resin, the amidoamine curing agent, the interfacial material and the migrating agent are selected such that the adhesive composition when cured forms good bonds to the reinforcing fiber, and wherein the interfacial material has a gradient in concentration in an interfacial region between the reinforcing fiber and the adhesive composition.

26. The fiber reinforced polymer composition of claim 25, wherein the amidoamine curing agent comprises at least one aromatic group.

27. (canceled)

28. The fiber reinforced polymer composition of claim 2726, additionally comprising an accelerator, a toughener, a filler, an interlayer toughener or a combination thereof.

29. A fiber reinforced polymer composition comprising a reinforcing fiber and an adhesive composition, wherein the adhesive composition comprises at least a thermosetting resin and an aromatic amidoamine curing agent, and wherein the fiber reinforced polymer composition when cured has an interlaminar shear strength (ILSS) of at least 90 MPa (13 ksi), a tensile strength providing a translation of at least 70%, a compression strength of at, least 1380 Mpa (200 ksi), and a mode I fracture toughness of at least 350 J/m² (2 lb·in/in²).
